(19) United States
(12) Patent Application Publication
(10) Pub. No.: US 2019/0185611 A1
(43) Pub. Date: Jun. 20, 2019

(54) PROCESS FOR PRODUCING POLYMER FOAMS COMPRISING IMIDE GROUPS

(71) Applicant: BASF SE, Ludwigshafen am Rhein (DE)

(72) Inventors: Anna Maria Mueller-Cristadoro, Ludwigshafen (DE); Frank Prissok, Lemfoerde (DE)

(21) Appl. No.: 16/328,086

(22) PCT Filed: Aug. 18, 2017
(86) PCT No.: PCT/EP2017/070923

§ 371 Date: Feb. 25, 2019

(30) Foreign Application Priority Data
Aug. 26, 2016 (EP) 16185843.6

(51) Int. Cl. C08G 18/78; C08J 9/08; C08J 9/00; C08G 18/48; C08G 18/42; C08G 18/20; C08J 9/12

(52) U.S. Cl. CPC C08G 18/7881; C08J 9/08; C08J 9/0061; C08G 18/4825; C08G 2101/0025; C08G 18/2027; C08J 9/0042; C08J 9/125; C08G 18/42

(57) ABSTRACT

A process for producing a polymer foam including reacting components A to C in the presence of component D and optionally E or of an isocyanate-functional prepolymer of components A and B with component C in the presence of component D and optionally E. The polymer foam includes 35 to 75 wt % of at least one polyisocyanate component A, 5 to 50 wt % of at least one polyol component B, 1 to 10 wt % of water as component C, 0.01 to 3 wt % of at least one Lewis base component D, and optionally 0 to 5 wt % of at least one foam stabilizer component E. Component A is a condensation product including polyimide groups and obtained by condensing at least one polyisocyanate component with at least one polycarboxylic acid having at least 3 COOH groups per molecule or anhydride. The process is effected to release carbon dioxide.

The present invention relates to a process for producing a polymer foam comprising imide groups, to the polymer foam thus obtainable, to the use in its preparation of polyisocyanates comprising imide groups and to its use.

Polymer foams, such as polyurethane and polyurethane-polyurea foams based on di- or polyisocyanates are well known. Rigid polyurethane phases have a distinctly lower melting temperature compared with a rigid polyamide phase which has a decisive influence on using the materials at high temperatures.

It is further known to react carboxylic acids with isocyanates to form mixed carbamic anhydrides with partial further reaction to form amides. The reaction and the reaction mechanism are described for example by R. W. Hoffman in Synthesis 2001, No. 2, 243-246 and I. Scott in Tetrahedron Letters, Vol. 27, No. 11, pp 1251-1254, 1986.

Oligomeric compounds from a reaction between a diisocyanate and a dicarboxylic acid are described by K. Onder in Rubber Chemistry and Technology, Vol. 59, pages 615-622 and by T. O. Ahn in Polymer Vol. 39, No. 2, pp. 459-456, 1998.

EP 0 527 613 A2 describes the production of foams comprising amide groups. These are produced using organic polyisocyanates and polyfunctional organic acids. The foams are produced using an addition reaction by reacting an organic polyisocyanate with the reaction product of a polyoxyalkylene and of an organic polycarboxylic acid component. The two isocyanate groups react with a compound which generates carbon dioxide. This compound is the reaction product of a polyoxyalkylene polyamine or of a polyol component with an organic polycarboxylic acid component. The polyoxyalkylenepolyamine or polyol component has an average molecular weight of 200 to 5000 g/mol. The starting temperature for the reaction is at least 150° C., while the reaction time is in a range from half an hour to twelve hours.

DE 42 02 758 A1 describes a foam comprising urethane and amide groups which is obtainable by using polyhydroxycarboxylic acids having a chain length of 8 to 200 carbon atoms. These polyhydroxycarboxylic acids are conveniently produced by ring-opening epoxidized unsaturated fatty acids with hydroxyl-containing compounds, such as water, alcohol or hydroxycarboxylic acids. Foam densities range from 33 to 190 kg/m³.

The known polyurethane-polyamide foams are disadvantageous because the starting materials either only react at comparatively high temperatures or do not react to completion, and their density is not in line with standard polyurethane recipes.

WO 2011/147723 describes construction materials comprising at least one rubber and at least one polyimide, wherein said polyimide is a branched condensation product of at least one polyisocyanate having on average more than two isocyanate groups per molecule and at least one polycarboxylic acid having at least three carboxyl groups per molecule or anhydride thereof. The polyimide is employed to improve the attachment of polyurethanes to rubbers.

The present invention has for its object to provide polymer foams that are dimensionally stable even at high temperatures in the presence of moisture and/or at high pressures, so that they can even be used in the engine, transmission or exhaust environment, and their methods of making. The polymer foams shall further have advantageous properties with respect to crushing strength, stiffness, elasticity and compressive stresses. The present invention further has for its object to provide a polymer foam having urea groups while a reaction of diisocyanate components with water generates carbon dioxide, ideally eliminating any need for additional blowing agents. The absence of additional blowing agents in the foams shall also yield advantages in the event of the foams burning, for example a lower toxicity for the fire gases and/or residues.

We have found that these objects are achieved according to the present invention by a process for producing a polymer foam comprising reacting components A to C in the presence of component D and optionally E or of an isocyanate-functional prepolymer of components A and B with component C in the presence of component D and optionally E, the total amount of which is 100 wt %,
(A) 35 to 75 wt % of at least one polyisocyanate component A, wherein 10 to 100 wt % of component A is a condensation product comprising polyimide groups and obtained by condensing at least one polyisocyanate component with at least one polycarboxylic acid having at least 3 COOH groups per molecule or anhydride thereof,
(B) 5 to 50 wt % of at least one polyol component B,
(C) 1 to 10 wt % of water as component C, and
(D) 0.01 to 3 wt % of at least one Lewis base component D,
(E) 0 to 5 wt % of at least one foam stabilizer component E,

wherein said reacting is effected to release carbon dioxide. Further ingredients may be present in the reaction mixture in addition to components A to D and optionally E.

The process of the present invention involves the reaction of water with an isocyanate group to form a carbamic acid which then eliminates CO₂ to form an amine. CO₂ elimination from the carbamic acid using Lewis bases as catalysts provides the polymer foams of the present invention rapidly and preferably without further addition of blowing agent. The amine-functional components present in the reaction mixture and the isocyanate groups of component A combine to form urea groups, while the alcohol-functional component B and the isocyanate groups of component A combine to form urethane groups, so the present invention provides for the formation of polyureas and polyurethanes that include building blocks comprising imide groups.

The polymer foam may have different properties. It may be, for example, a rigid foam or a flexible foam. The polymer foam may preferably be a rigid polymer foam. The process of the present invention is accordingly preferable when the polymer foam is a rigid polymer foam. PIR foams may also be present for the purposes of the present invention.

A rigid polymer foam can be understood as meaning in the context of the present invention that, in the course of the production of the rigid polymer foam, the reaction mixture undergoes a volume change until the reaction has finally ended, even after the main reaction has ended, since the foam matrix is still viscous and the gas can continue to expand within the foam. It is advantageously possible for the polymer foam to include cells/cavities within the polymer foam and also on the surface of the polymer foam.

The rigid polymer foams of the present invention may preferably have a compressive stress at 10% relative deformation of not less than 80 kPa, preferably not less than 150 kPa and more preferably not less than 180 kPa.

The rigid polymer foam may further preferably have a DIN ISO 4590 closed-cell content of not less than 30% and preferably above 60%. Further details concerning preferred rigid polymer foams of the present invention appear in “Kunststoffhandbuch, Band 7, Polyurethane”, Carl Hanser Verlag, 3rd edition 1993, chapter 6. DIN 7726 can also be referenced for polyurethane foams.

The polymer foams of the present invention may preferably have a density of 10 to 250 kg/cm³, more preferably of 15 to 150 kg/cm³ and yet more preferably of 20 to 80 kg/cm³, all measured as core density. The polymer foam of the present invention may further preferably have a DIN 53421/DIN EN ISO 604 compressive strength of 0.05 to 0.25 N/mm², preferably of 0.10 to 0.20 N/mm². The polymer foam of the present invention may further preferably have a DIN 53421/DIN EN ISO 604 compression of 2.0 to 10.0%, preferably of 3.0 to 9.0%. The polymer foam of the present invention may further preferably have DIN ISO 11358 TGA of 260 to 280° C., preferably of 270 to 280° C.

The present invention utilizes the Lewis base component as an accelerant or catalyst in the reaction, making it possible for the polyaddition and the polycondensation to be carried out uniformly and at a high rate to ensure that not only the molecular weight buildup and the gelling of the resulting polymer but also the expansive foaming, especially due to the released carbon dioxide, take place simultaneously so as to form a stable uniform foam which then solidifies. The inventors found that the use of one Lewis base component for both the elementary reactions is sufficient and that the reactions coordinate with each other such that gas production and foam formation are simultaneously accompanied by a viscosity increase which leads to a uniform foam being produced. Once the viscosity has increased too much, foam formation can be impaired. If, during foam formation, the viscosity increase is insufficient and/or no gelling whatsoever has ensued, the produced gas is able to rise through the liquid polymer and escape therefrom and/or accumulate at the surface, preventing the formation of a uniform foam structure. These problems are overcome in the process of the present invention, resulting in a polymer foam having a uniform cellular distribution throughout the entire cross section of the polymer foam.

The present inventors further found that when the components are used in the amounts of the present invention, carbon dioxide formation is sufficient to produce a suitable polymer foam, eliminating the need to add external blowing agents. When a foam of lower density is desired, however, external physical blowing agents can also be additionally used.

Physical blowing agents in the context of this invention are substances that vaporize under the conditions of polyurea formation. They may be, for example, hydrocarbons, halogenated hydrocarbons and other compounds, for example perfluorinated alkanes, such as perfluorohexane, chlorofluorocarbons, ethers, esters, ketones and/or acetals, for example (cyclo)aliphatic hydrocarbons of 4 to 8 carbon atoms, or hydrofluorocarbons, such as 1,1,1,3,3-pentafluorobutane, for example Solkane® 365 mfc from Solvay Fluorides LLC.

Yet preferably the addition of external blowing agents is eschewed. Similarly, for the purposes of the present invention, an addition of polycarboxylic acids aside from the polycarboxylic acid present in component A is largely or entirely avoided. Polycarboxylic acids aside from the polycarboxylic acids present in component A are preferably not comprised in the reaction mixture.

In a preferred embodiment, therefore, the reaction mixture of the present invention comprises 0 wt % of at least one polycarboxylic acid in addition to the polycarboxylic acid having at least 3 COOH groups per molecule or anhydride thereof in component A.

Employing, as portion or replacement of polyisocyanate component A, a condensation product comprising polyimide groups and obtained by condensing at least one polyisocyanate component with at least one polycarboxylic acid having at least three carboxyl groups per molecule or anhydride thereof, yields a yet further improvement in the thermal stability of the foams formed.

The individual components used according to the present invention will now be more particularly described.

Polyisocyanate component A employed according to the present invention comprises from 10 to 100 wt %, preferably from 50 to 100 wt % and particularly from 70 to 100 wt % of a condensation product comprising polyimide groups and obtained by condensing at least one polyisocyanate component with at least one polycarboxylic acid having at least three carboxyl groups per molecule or anhydride thereof, as component A2, in addition to from 0 to 90 wt %, preferably from 0 to 50 wt %, especially from 0 to 30 wt %, of a polyisocyanate component A1 comprising no polyimide groups. In a particularly preferred embodiment, therefore, the polyisocyanate component A employed according to the present invention consists of a condensation product comprising polyimide groups and obtained by condensing at least one polyisocyanate component with at least one polycarboxylic acid having at least three carboxyl groups per molecule or anhydride thereof (A2). In a further preferred embodiment, component A comprises not only the condensation product of at least one polyisocyanate component with at least one polycarboxylic acid having at least three carboxyl groups per molecule or anhydride thereof but also at least one further polyisocyanate, for example in the abovementioned amounts.

The polyisocyanate component A2 is derivable by reacting the polyisocyanate component A1 with at least one polycarboxylic acid having at least three carboxyl groups per molecule or anhydride thereof. Therefore, polyisocyanate component A1 is described first, followed by its reaction with polycarboxylic acids to form polyisocyanate component A2 comprising polyimide groups.

For the purposes of the present invention, at least one polyisocyanate component, herein also referred to as component A1, comprises polyfunctional aromatic and/or aliphatic isocyanates, for example diisocyanates.

It may be advantageous for the polyisocyanate component A1 to have an isocyanate group functionality in the range from 1.8 to 5.0, more preferably in the range from 1.9 to 3.5 and most preferably in the range from 2.0 to 3.0.

It is preferable for the suitable polyfunctional isocyanates to comprise on average from 2 to not more than 4 NCO groups. Examples of suitable isocyanates are 1,5-naphthylene diisocyanate, xylylene diisocyanate (XDI), tetramethylxylylene diisocyanate (TMXDI), diphenyldimethylmethane diisocyanate derivatives, di- and tetraalkyldiphenylmethane diisocyanate, 4,4-dibenzyl diisocyanate, 1,3-phenylene diisocyanate, 1,4-phenylene diisocyanate, the isomers of tolylene diisocyanate (TDI), optionally in admixture, 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), chlorinated and brominated diisocyanates, phosphorus-containing diisocyanates, 4,4 -diisocyanatophenylperfluoroethane, tetramethoxybutane 1,4-diisocyanate, butane 1,4-diisocyanate, hexane 1,6-diisocyanate (HDI), dicyclohexylmethane diisocyanate, cyclohexane 1,4-diisocyanate, ethylene diisocyanate, bisisocyanatoethyl phthalate, also polyisocyanates with reactive halogen atoms, such as 1-chloromethylphenyl 2,4-diisocyanate, 1-bromomethylphenyl 2,6-diisocyanate, 3,3-bischloromethyl ether 4,4 min -diphenyl diisocyanate.

Further important diisocyanates are trimethylhexamethylene diisocyanate, 1,4-diisocyanatobutane, 1,12-diisocyanatododecane and dimer fatty acid diisocyanate.

4,4-Diphenylmethane diisocyanate (MDI), 2,4-diphenylmethane diisocynate (MDI), hydrogenated MDI (H12MDI) and polymeric methylene diphenyl diisocyanate are particularly suitable and the polymeric methylene diphenyl diisocyanate advantageously has a functionality of not less than 2.2.

In a further embodiment of the process according to the present invention, component A1 has an average molecular weight in the range from 100 g/mol to 750 g/mol, advantageously in the range from 130 g/mol to 500 g/mol and especially in the range from 250 g/mol to 450 g/mol.

To prepare polyisocyanate component A2, polyisocyanate component A1 may be subjected to a condensation reaction with at least one polycarboxylic acid having at least three carboxyl groups per molecule or anhydride thereof to obtain a condensation product comprising polyimide groups. The polycarboxylic acid used for this purpose is also referred to as component A2b, while the A2a polyisocyanate component employed may correspond to polyisocyanate component A1.

Polycarboxylic acids A2b are selected from aliphatic or preferably aromatic polycarboxylic acids having at least three COOH groups per molecule, or the corresponding anhydrides, preferably when they are in low molecular weight, i.e., nonpolymeric, form. This also encompasses polycarboxylic acids with three COOH groups where two carboxylic acid groups are present as anhydride and the third is present as free carboxylic acid.

In a preferred embodiment of the present invention, polycarboxylic acid A2b is a polycarboxylic acid having at least 4 COOH groups per molecule or the corresponding anhydride.

Examples of polycarboxylic acids A2b and anhydrides thereof are 1,2,3-benzenetricarboxylic acid and 1,2,3-benzenetricarboxylic dianhydride, 1,3,5-benzenetricarboxylic acid (trimesic acid), preferably 1,2,4-benzenetricarboxylic acid (trimellitic acid), trimellitic anhydride and especially 1,2,4,5-benzenetetracarboxylic acid (pyromellitic acid) and 1,2,4,5-benzenetetracarboxylic dianhydride (pyromellitic dianhydride), 3,3′,4,4″-benzophenonetetracarboxylic acid, 3,3′,4,4″-benzophenonetetracarboxylic dianhydride, also benzenehexacarboxylic acid (mellitic acid) and anhydrides of mellitic acid.

Useful polycarboxylic acids and anhydrides further include mellophanic acid and mellophanic anhydride, 1,2,3,4-benzenetetracarboxylic acid and 1,2,3,4-benzenetetracarboxylic dianhydride, 3,3,4,4-biphenyltetracarboxylic acid and 3,3,4,4-biphenyltetracarboxylic dianhydride, 2,2,3,3-biphenyltetracarboxylic acid and 2,2,3,3-biphenyltetracarboxylic dianhydride, 1,4,5,8-naphthalenetetracarboxylic acid and 1,4,5,8-naphthalenetetracarboxylic dianhydride, 1,2,4,5-naphthalenetetracarboxylic acid and 1,2,4,5-naphthalenetetracarboxylic dianhydride, 2,3,6,7-naphthalenetetracarboxylic acid and 2,3,6,7-naphthalenetetracarboxylic dianhydride, 1,4,5,8-decahydronaphthalenetetracarboxylic acid and 1,4,5,8-decahydronaphthalene-tetracarboxylic dianhydride, 4,8-dimethyl-1,2,3,5,6,7-hexahydronaphthalene-1,2,5,6-tetra-carboxylic acid and 4,8-dimethyl-1,2,3,5,6,7-hexahydronaphthalene-1,2,5,6-tetracarboxylic dianhydride, 2,6-dichloronaphthalene-1,4,5,8-tetracarboxylic acid and 2,6-dichloronaphthalene-1,4,5,8-tetracarboxylic dianhydride, 2,7-dichloronaphthalene-1,4,5,8-tetracarboxylic acid and 2,7-dichloronaphthalene-1,4,5,8-tetracarboxylic dianhydride, 2,3,6,7-tetrachloronaphthalene-1,4,5,8-tetracarboxylic acid and 2,3,6,7-tetrachloronaphthalene-1,4,5,8-tetracarboxylic dianhydride, 1,3,9,10-phenanthrenetetracarboxylic acid and 1,3,9,10-phenanthrene-tetracarboxylic dianhydride, 3,4,9,10-perylenetetracarboxylic acid and 3,4,9,10-perylene-tetracarboxylic dianhydride, bis(2,3-dicarboxyphenyl)methane and bis(2,3-dicarboxy-phenyl)methane dianhydride, bis(3,4-dicarboxyphenyl)methane and bis(2,3-dicarboxy-phenyl)methane dianhydride, bis(3,4-dicarboxyphenyl)methane and bis(3,4-dicarboxy-phenyl)methane dianhydride, 1,1-bis(2,3-dicarboxyphenyl)methane and 1,1-bis(2,3-dicarboxy-phenyl)ethane dianhydride, 1,1-bis(3,4-dicarboxyphenyl)ethane and 1,1-bis(3,4-dicarboxy-phenyl)ethane dianhydride, 1,1-bis(3,4-dicarboxyphenyl)ethane and 1,1-bis(3,4-dicarboxy-phenyl)ethane dianhydride, 2,2-bis(2,3-dicarboxyphenyl)propane and 2,2-bis(2,3-dicarboxy-phenyl)propane dianhydride, 2,3-bis(3,4-dicarboxyphenyl)propane and 2,3-bis(3,4-dicarboxy-phenyl)propane dianhydride, bis(3,4-carboxyphenyl) sulfone and bis(3,4-carboxyphenyl) sulfone dianhydride, bis(3,4-carboxyphenyl) ether and bis(3,4-carboxyphenyl) ether dianhydride, ethylenetetracarboxylic acid and ethylenetetracarboxylic dianhydride, 1,2,3,4-butane-tetracarboxylic acid and 1,2,3,4-butanetetracarboxylic dianhydride, 1,2,3,4-cyclopentane-tetracarboxylic acid and 1,2,3,4-cyclopentanetetracarboxylic dianhydride, 2,3,4,5-pyrrolidinetetracarboxylic acid and 2,3,4,5-pyrrolidinetetracarboxylic dianhydride, 2,3,5,6-pyrazinetetracarboxylic acid and 2,3,5,6-pyrazinetetracarboxylic dianhydride, 2,3,4,5-thiophenetetracarboxylic acid and 2,3,4,5-thiophenetetracarboxylic dianhydride.

It is preferable according to the present invention to use 1,2,4,5-benzenetetracarboxylic acid or its anhydride.

In one embodiment of the present invention, anhydrides from U.S. Pat. No. 2,155,687 or U.S. Pat. No. 3,277,117 are used to synthesize component A2.

When polyisocyanate A2a and polycarboxylic acid A2b are condensed with each other, which is preferably done in the presence of a catalyst, an imide group is formed by elimination of CO₂ and H₂O. When the anhydride of polycarboxylic acid A2b is used instead, an imide group is formed by elimination of CO₂.

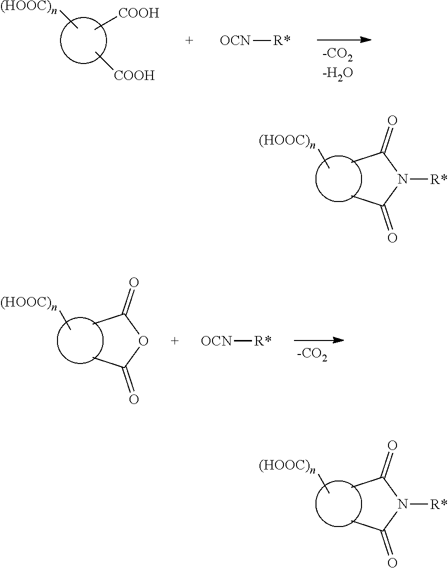

In the above reaction equation, the R* moiety of polyisocyanate A2a does not have to be further specified and n is not less than 1, for example 1 in the case of a tricarboxylic acid or 2 in the case of a tetracarboxylic acid, while (HOOC)ₙ can be replaced by an anhydride group of the formula C(═O)—O—C(═O).

One embodiment of the present invention utilizes polyisocyanate A2a in admixture with at least one diisocyanate, for example with tolylene diisocyanate, hexamethylene diisocyanate or with isophorone diisocyanate. One particular version utilizes polyisocyanate A2a in a mixture with the corresponding diisocyanate, for example trimeric HDI with hexamethylene diisocyanate or trimeric isophorone diisocyanate with isophorone diisocyanate or polymeric diphenylmethane diisocyanate (polymer MDI) with diphenylmethane diisocyanate.

One embodiment of the present invention utilizes polycarboxylic acid A2b in admixture with at least one dicarboxylic acid or with at least one dicarboxylic anhydride, for example with phthalic acid or phthalic anhydride.

Components A2a and A2b are preferably used in a weight ratio ranging from 20:1 to 1:1, more preferably from 10:1 to 2:1 and especially from 7:1 to 3:1.

The synthesis of the present invention may preferably be carried out by using polyisocyanate (A2a) and polycarboxylic acid (A2b) or anhydride (A2b) in a mixing ratio such that the molar fraction of NCO groups relative to COOH groups is in the range from 1:3 to 3:1 and preferably in the range from 1:2 to 2:1. One anhydride group of the formula CO—O—CO here counts as two COOH groups.

Component A2 preferably has a molecular weight M_{w} in the range from 1000 to 200 000 g/mol.

Component A2 preferably has at least two imide groups per molecule and more preferably at least three imide group per molecule.

Component A2 may be composed of structurally and molecularly uniform molecules or comprise a mixture of molecular-structurally different molecules. For example, the polydispersity M_{W}/Mₙ may be not less than 1.4, for example in the range from 1.4 to 50 and preferably in the range from 1.5 to 10. Polydispersity can be determined by known methods, especially by gel permeation chromatography (GPC). Polymethyl methacrylate (PMMA) for example is a suitable standard for this.

Component A2 may in addition to the imide groups in the polymer scaffolding comprise end- or side-disposed functional groups, which may be anhydride or acid groups as well as free or blocked NCO groups.

This polyisocyanate component may ideally provide a high density of imide bonds per polymer unit which is produced in the process of the present invention. This makes it possible to generate a rigid phase having advantageous properties. Imides have higher melting points and higher decomposition temperatures than urethanes. Rigid polymer foams having a higher proportion of imide bonds therefore likewise have a higher melting point and a higher decomposition temperature and hence are particularly suitable for high-temperature applications, for example as insulating material in the engine compartment of a motor vehicle. The presence of imide bonds provides for a still further improvement in the thermal stability. Component A2 preferably has a number-average molecular weight in the range from 1000 to 10 000 g/mol and more preferably in the range from 2000 to 5000 g/mol.

The process of the present invention involves the reaction of 35-75 wt % of at least one polyisocyanate component A, preferably of 40-70 wt % of at least one polyisocyanate component A and more preferably of 60-70 wt % of at least one polyisocyanate component A. More particularly, component A can be contacted with the particular components B, C and D and optionally E together, in succession or with each one first. For example, components A and B can be reacted to produce an isocyanate-functional prepolymer. This prepolymer in turn has an isocyanate functionality of preferably 2.5 to 3.

For the purposes of the present invention, at least one polyol component B, herein also referred to as component B, comprises organic compounds having two or more free hydroxyl groups. These compounds are preferably free of other functional groups or reactive groups, such as acid groups. Preferably, polyol component B is a polyether polyol or a polyester polyol. Examples thereof are a polyoxyalkylene, a polyoxyalkenyl, a polyester diol, a polyesterol, a polyether glycol, especially a polypropylene glycol, a polyethylene glycol, a polypropylene glycol, a polypropylene ethylene glycol, or mixtures thereof. A mixture can be understood as meaning for example a copolymer, but also a mixture of polymers. The polyglycol component preferably has an average molecular weight in the range from 200 g/mol to 6000 g/mol, especially in the range from 250 g/mol to 3000 g/mol and more preferably in the range from 300 g/mol to 800 g/mol.

Polyether polyols useful for the purposes of the present invention are prepared according to known methods. They are obtainable, for example, by anionic polymerization with alkali metal hydroxides, for example sodium hydroxide or potassium hydroxide, or alkali metal alkoxides, for example sodium methoxide, sodium ethoxide, potassium ethoxide or potassium isopropoxide, as catalysts and in the presence of at least one starter molecule having from 2 to 8, preferably from 2 to 6, reactive hydrogen atoms, or by cationic polymerization with Lewis acids, such as antimony pentachloride, boron fluoride etherate among others, or fuller's earth as catalyts. Polyether polyols are similarly obtainable via double metal cyanide catalysis from one or more alkylene oxides having 2 to 4 carbon atoms in the alkylene moiety. Tertiary amines are also employable as catalysts, examples being triethylamine, tributylamine, trimethylamine, dimethylethanolamine, imidazole or dimethylcyclohexylamine. For specialty applications, monofunctional starters may also be included in the polyether polyol construction.

Suitable alkylene oxides include, for example, tetrahydrofuran, 1,3-propylene oxide, 1,2-butylene oxide, 2,3-butylene oxide, styrene oxide and preferably ethylene oxide and 1,2-propylene oxide. Alkylene oxides may be used singly, alternatingly in succession or as mixtures. Starter molecules include, for example, water, aliphatic and aromatic, optionally N-monoalkyl-, N,N- and N,N′-dialkyl-substituted diamines having 1 to 4 carbon atoms in the alkyl moiety, such as optionally mono- and dialkyl-substituted ethylenediamine, diethylenetriamine, triethylenetetramine, 1,3-propylenediamine, 1,3-butylenediamine, 1,4-butylenediannine, 1,2-hexannethylenediannine, 1,3-hexannethylenediannine, 1,4-hexamethylenediamine, 1,5-hexannethylenediannine, 1,6-hexannethylenediannine, phenylenediamine, 2,3-, 2,4- and 2,6-tolylenediamine (TDA) and 4,4′-, 2,4′- and 2,2′-diaminodiphenylmethane (MDA) and polymeric MDA. Useful starter molecules further include alkanolamines, for example ethanolamine, N-methylethanolamine and N-ethylethanolamine, dialkanolamines, for example diethanolamine, N-methyldiethanolamine and N-ethyldiethanolamine, trialkanolamines, for example triethanolamine, and ammonia. Preference is given to using polyhydric alcohols, such as ethanediol, 1,2-propanediol, 2,3-propanediol, diethylene glycol, dipropylene glycol, 1,4-butanediol, 1,6-hexanediol, glycerol, trimethylolpropane; pentaerythritol, sorbitol and sucrose, and mixtures thereof. Polyether polyols may be used singly or in the form of mixtures.

Polyester polyols are prepared for example from alkanedicarboxylic acids and polyhydric alcohols, polythioether polyols, polyester amides, hydroxyl-containing polyacetals and/or hydroxyl-containing aliphatic polycarbonates, preferably in the presence of an esterification catalyst. Further possible polyols are indicated for example in “Kunststoffhandbuch, Band 7, Polyurethane”, Carl Hanser Verlag, 3rd edition 1993, chapter 3.1.

Preferably used polyester polyols are obtainable for example from dicarboxylic acids having 2 to 12 carbon atoms, preferably 4 to 6 carbon atoms, and polyhydric alcohols. Useful dicarboxylic acids include for example: aliphatic dicarboxylic acids, such as succinic acid, glutaric acid, adipic acid, suberic acid, azelaic acids and sebacic acid and aromatic dicarboxylic acids, such as phthalic acid, isophthalic acid and terephthalic acid. Dicarboxylic acids are usable singly or as mixtures, for example in the form of a succinic, glutaric and adipic acid mixture. To prepare polyesterols, it may optionally be advantageous to use not the dicarboxylic acids but the corresponding dicarboxylic acid derivatives, such as dicarboxylic esters having 1 to 4 carbon atoms in the alcohol moiety, dicarboxylic anhydrides or dicarbonyl chlorides. Examples of polyhydric alcohols are glycols having 2 to 10, preferably 2 to 6 carbon atoms, such as ethylene glycol, diethylene glycol, 1,4-butanediol, 1,5-pentanediol, 1,6-hexanediol, 1,10-decanediol, 2,2-dimethyl-1,3-propanediol, 1,3-propanediol and dipropylene glycol, triols having 3 to 6 carbon atoms, for example glycerol and trimethylolpropane and, as a more highly hydric alcohol, pentaerythritol. Depending on the properties desired, polyhydric alcohols are usable alone or optionally in mixtures with each other.

The polyols employed as component B preferably comprise polyether polyols or polyester polyols, particular preference being given to employment of polyether polyols. In a particularly preferred embodiment, component B consists of polyether polyols.

The polyether polyol employed is preferably di- to tetrafunctional polyoxyalkylene oxide polyol having a hydroxyl number of 20 to 1000, preferably 100 to 900 and more preferably 300 to 450. The average functionality is preferably in the range from 2.5 to 3.5. The polyether polyol employed with preference preferably has a fraction of secondary hydroxyl groups which is greater than 70%, as a proportion of the total number of hydroxyl groups in the polyalkylene oxide polyol. The polyoxyalkylene oxide polyol preferably comprises at least 50 wt %, more preferably at least 80 wt % of propylene oxide, based on the alkylene oxide content of the polyalkylene oxide polyol.

In a further embodiment of the process according to the present invention, component B has an OH number of 10 mg KOH/g to 1000 mg KOH/g. More particularly, component B can have an OH number of 30 mg KOH/g to 500 mg KOH/g.

Components A and (B +C) may be used in a molar ratio of isocyanate groups on component A to isocyanate-reactive groups, such as hydroxyl or carboxylic acid groups on components B and C in the range of preferably 10:1 to 1:2, more preferably from 5:1 to 1:1.5 and especially from 3:1 to 1:1.

The proportion of component B in the reaction mixtures may preferably be in the range from 15 to 40 wt % and especially in the range from 25 to 35 wt %.

Component C for the purposes of the present invention utilizes from 1 to 10 wt %, preferably from 1.0 to 5 wt % or 1.2 to 5 wt %, more preferably from 1.0 to 2.5 wt % or 1.3 to 2.5 wt % and most preferably from 1.4 to 2.0 wt %, of water. The upper limit to the amount of water is more preferably 2.5 wt %.

Distilled or demineralized water, for example, is employable for the purposes of the present invention.

For the purposes of the present invention, at least one Lewis base component, herein also referred to as component D, may be understood as meaning a compound capable of providing electron pairs, for example in accordance with the meaning of the term “Lewis base” in chemistry. Preferably, the free electron pair is in an organic compound, but can also be bound to a metal or to an organometallic compound.

The Lewis base is preferably used in an amount of from 0.05 to 1 wt % and more preferably 0.1 to 0.5 wt %.

In a preferred embodiment of the process according to the present invention, the Lewis base component is selected from the group consisting of N-methylimidazole, melamine, guanidine, cyanuric acid, dicyandiamide or their derivatives. Ideally, the Lewis base is able to generate the formation of a carboxylate from the carboxylic acid, so that this carboxylate can quickly react with the diisocyanate component. The Lewis base likewise also functions as a catalyst for the detachment of CO₂ in the reaction of the diisocyanate component with water. A synergistic effect may particularly advantageously result from the formation of the carboxylate and the detachment of CO₂ using the Lewis base, and so only one catalyst or accelerant is needed.

In a further embodiment of the present invention, at least a PIR catalyst is added to the reaction mixture. This PIR catalyst catalyzes the reaction of three isocyanate groups at a time to form one polyisocyanurate (PIR) group, i.e., the PIR catalyst is employed when the formation of PIR groups is desired.

The at least one PIR catalyst optionally present may generally be any basic compound capable of being incorporated in the reaction mixture. Preferably, the at least one optionally present PIR catalyst is selected from the group of basic alkali or alkaline earth metal compounds. More preferably, the at least one optionally present PIR catalyst is selected from the group consisting of lithium hydroxide, lithium formate, lithium acetate, lithium propionate, lithium alkoxides, sodium hydroxide, sodium formate, sodium acetate, sodium propionate, sodium alkoxides, potassium hydroxide, potassium formate, potassium acetate, potassium propionate, potassium alkoxides, cesium hydroxide, cesium formate, cesium acetate, cesium propionate, cesium alkoxides, ammonium hydroxide, ammonium formate, ammonium acetate, ammonium propionate, ammonium alkoxides and mixtures thereof. Corresponding alkoxides are derived for example from alcohols selected from the group consisting of methanol, ethanol, propanol, isopropanol, butanol, hexanol, heptanol, octanol and mixtures thereof, preferably selected from the group consisting of ethanol, propanol, isopropanol, hexanol, heptanol and mixtures thereof.

In a preferred embodiment, the corresponding amount of the at least one PIR catalyst is taken up in a suitable dissolving and/or suspending medium, for example a glycol, and added to the reaction mixture.

The at least one PIR catalyst is generally employed in an amount of 0.1 to 5 wt %, preferably 0.2 to 3 wt %, more preferably from 0.5 to 2 wt %, all based on the total amount of components present.

In a further embodiment of the process according to the present invention, the reaction takes place in the presence of at least one foam stabilizer as component E, and said stabilizer E preferably comprises a siloxane copolymer. This polysiloxane copolymer is preferably selected from the group comprising polyether-polysiloxane copolymers, such as polyether-polydimethylsiloxane copolymers.

The proportion of component E is in the range from 0 to 5 wt %, preferably in the range from 0 to 3 wt % and especially in the range from 0 to 1 wt %. When foam stabilizer component E is used, its proportion is preferably in the range from 0.1 to 5 wt %, more preferably in the range from 0.3 to 3 wt % and especially in the range from 0.5 to 1 wt %.

The total amounts of components A to E always sum according to the invention to 100 wt %. This means that the reaction mixture can but need not contain further components other than A to E. If further components are present as well as components A to E, these amounts add up to the stated 100%. The quantitative recitations of components A to E are standardized with regard to their sum total.

The process for producing a polymer foam can be carried out at a starting temperature in the range from at least 15° C. to at most 100° C., more preferably from at least 15° C. to at most 80° C., especially at a starting temperature from at least 25° C. to at most 75° C. and more preferably at a starting temperature from at least 30° C. to at most 70° C. The reaction of the abovementioned components can take place at atmospheric pressure. This reduces for example the energy requirements of producing the polymer foam. It is similarly possible to circumvent the disadvantageous effect of a higher temperature on the formation of a scorched core, and gas production/foam formation and viscosity increase are well matched to each other, as described above.

The reactor and the reaction mixture are preferably controlled to the temperature at which the reaction is started. The temperature can rise in the course of the reaction. Typically, the receptacle in which the reaction takes place is not separately heated or cooled, and so the heat of reaction is removed to the environment via the receptacle walls or the air. Since the reaction is accelerated by the Lewis base component used in the process of the present invention in that the Lewis base acts as a catalyst, the process of the present invention provides complete and rapid further reaction between diisocyanate components and water to form an amide component. In this case, advantageously, the reaction need not be carried out under the conditions of an elevated temperature, as described in EP 0 527 613 A2 for example.

In a preferred embodiment of the process according to the invention, the reaction to form the polymer foam starts after at least 3 to 90 seconds, especially after 5 to 70 seconds and most preferably after 5 to 40 seconds. The reaction starting is to be understood as meaning that components A, B, C and D react to form the corresponding product(s) after they have been brought into contact with one another. Advantageously, externally heated components or reactors are not needed.

The present invention further provides a polymer foam deriving from polyisocyanates being to an extent of at least 10 wt %, preferably 100 wt %, condensation products comprising polyimide groups and obtained by condensing at least one polyisocyanate with at least one polycarboxylic acid having at least 3 COOH groups per molecule or anhydride thereof, polyols or an isocyanate-functional prepolymer thereof as monomers and water, including urethane, imide and urea groups in the polymer main chain and preferably having a foam density in the range from 10 kg/m³ to 250 kg/m³.

The invention further provides the use of polyisocyanates being to an extent of at least 10 wt %, preferably 100 wt %, condensation products comprising polyimide groups and obtained by condensing at least one polyisocyanate with at least one polycarboxylic acid having at least 3 COOH groups per molecule or anhydride thereof, in the manufacture of polymer foams.

For the purposes of the present invention, a polyaddition product is a chemical reaction product where the reactants react with each or one another without the formation of low molecular weight by-products, as for example water or CO₂, in urethane formation for example. For the purposes of the present invention, a polycondensation product can be understood as meaning a product which, in the reaction of two reactants, provides at least one low molecular weight by-product, for example carbon dioxide in amide formation.

The present invention further provides the use of the polymer foam according to the invention for thermal insulation or as an engineering material.

For thermal insulation, the use preferably takes the form of being for production of refrigerator or freezer appliances, appliances for hot water preparation or storage or parts thereof, or for thermal insulation of buildings, vehicles or appliances.

In the above applications especially, the polymer foam of the present invention is used to form the thermal insulating layer in the devices or appliances, buildings or vehicles. The polymer foam of the present invention can also be used to form the entire housing or outer shells of appliances, buildings or vehicles.

As an engineering material, the polymer foam of the present invention is preferably used as core foam for producing sandwich composites. Sandwich composites of this type typically have a core of a polymer foam and are paneled or sheathed with wood, metal or preferably a fiberglass-reinforced plastic. This sheathing or paneling plastic is freely choosable. Epoxy or polyester resins are frequently concerned.

Sandwich composites of this type are preferentially used in the automotive, shipbuilding, building construction or wind power industry.

For the purposes of the present invention, vehicles are air, land or water vehicles, especially airplanes, automobiles or ships.

A person skilled in the art will be aware of further uses for the polymer foams of the present invention.

The examples which follow will further elucidate the invention:

### EXAMPLES

Molecular weights in the examples which follow were determined by gel permeation chromatography (GPC). Polymethyl methacrylate (PMMA) was used as standard. The solvent used was dimethylacetamide (DMAc). The NCO content was determined by NCO titration. The syntheses were carried out under nitrogen, unless otherwise stated.

Preparation of MDI-imide

A 4 L four-neck flask equipped with dropping funnel, reflux condenser, internal thermometer and

Teflon tube was initially charged with 100 g of 1,2,4,5-benzenetetracarboxylic dianhydride (0.64 mol) dissolved in 1500 ml of acetone, and 0.1 g of water was added. This was followed at 20° C. by the dropwise addition of 465 g of polymeric 4,4′-diphenylmethane diisocyanate (methylene diphenylene diisocyanate) having an average molar mass of 337 g/mol and a functionality of 2.5 (i.e., 2.5 isocyanate groups per molecule) (1.38 mol). The mixture was heated to 55° C. with stirring and refluxed at this temperature for a further 6 hours with further stirring. The mixture was then diluted with 1000 g of polymeric 4,4′-diphenylmethane diisocyanate and heated to 55° C. with stirring. The mixture was refluxed at 55° C. for a further six hours with stirring. Subsequently, the acetone was distilled off at atmospheric pressure over a period of one hour. At the end of the distillation, the residue thus obtained was stripped with nitrogen at 70° C. and 200 mbar to obtain an MDI-imide having an isocyanate functionality of

27% (measured via IR)

Mₙ=3200 g/mol, M_{w}=4850 g/mol

M_{w}/Mₙ=1.5

The MDI-imide thus obtained was used hereinbelow to produce the polymer foams.

Production of Polymer Foams

The examples hereinbelow demonstrate the production and properties of the polyimide polyurethanes of the present invention. The materials of the present invention were produced in the lab using a blender. To determine the physical properties, foam cubes having a volume of 20 I were produced and subsequently subjected to mechanical testing. The compositions of the starting substances are reported in Table 1.

TABLE 1

| | Example 1 | Example 2 | Example 3 | Example 4 |
|---|---|---|---|---|
| | (comparative) | (comparative) | (inventive) | (inventive) |
| polyol | 4.8 | 21.1 | 28.8 | 33.5 |
| MDI-imide | 90.1 | 75 | 67.9 | 63.5 |
| stabilizer | 0.2 | 0.8 | 1.1 | 1.3 |
| Lewis base | 0.1 | 0.2 | 0.2 | 0.2 |
| blowing agent | 4.8 | 2.9 | 2 | 1.4 |

The meanings are:

polyol: polypropylene glycol with average molecular weight (MW) 420 g/mol

blowing agent: water

MDI-imide: polyimide based on benzenetetracarboxylic dianhydride and polymeric methylenediphenylene diisocyanate having a free isocyanate content of 27%

stabilizer: polyether-polysiloxane copolymer

Lewis base: 1-methylimidazole

Example 1 (Comparative)

The components as per Table 1 with the exception of the MDI-imide were weighed in together pro rata for an overall batch size of 2.5 parts and then homogenized. This mixture was vigorously admixed with 22.5 parts of MDI-imide using a lab stirrer. No foam structure was produced. It proved impossible to produce a testable foam specimen.

Example 2 (Comparative)

The components as per Table 1 with the exception of the MDI-imide were weighed in together pro rata for an overall batch size of 12.5 parts and then homogenized. This mixture was vigorously admixed with 37.5 parts of MDI-imide using a lab stirrer. This produced an unstable foam, which collapsed to some extent. It proved impossible to produce a testable foam specimen.

Example 3 (Inventive)

The components as per Table 1 with the exception of the MDI-imide were weighed in together pro rata for an overall batch size of 256.8 parts and then homogenized. This mixture was vigorously admixed with 543.2 parts of MDI-imide using a lab stirrer and then poured into the cube mold. The foam rose in the mold and was left therein until fully cured.

Example 4 (Inventive)

The components as per Table 1 with the exception of the MDI-imide were weighed in together pro rata for an overall batch size of 200 parts and then homogenized. This mixture was vigorously admixed with 347.4 parts of MDI-imide using a lab stirrer and then poured into the cube mold. The foam rose in the mold and was left therein until fully cured.

Properties of Products Obtained

TABLE 2

| | Example 3 | Example 4 |
|---|---|---|
| | (inventive) | (inventive) |
| density | 29 | 36 |
| compressive strength | 0.12 | 0.16 |
| relative deformation | 8.3 | 3.7 |

density core density [kg/m³]

compressive strength in N/mm² to DIN 53421/DIN EN ISO 604

relative deformation [%] to DIN 53421/DIN EN ISO 604

TABLE 3

| | Example 3 | Example 4 |
|---|---|---|
| | (inventive) | (inventive) |
| density | 29 | 36 |
| closed-cell content | 33 | 68 |
| TGA | 276 | 276 |

density core density [kg/m³]

closed-cell content [%] to DIN ISO 4590
TGA thermogravimetric analysis [° C.] to DIN EN ISO 11358, evaluation on basis of absolute value at 95% of starting sample mass

1. A process for producing a polymer foam comprising reacting components A to C in the presence of component D and optionally E or of an isocyanate-functional prepolymer of components A and B with component C in the presence of component D and optionally E, the total amount of which is 100 wt %,
(A) 35 to 75 wt % of at least one polyisocyanate component A, wherein 10 to 100 wt % of component A is a condensation product comprising polyimide groups and obtained by condensing at least one polyisocyanate component with at least one polycarboxylic acid having at least 3 COOH groups per molecule or anhydride thereof,
(B) 5 to 50 wt % of at least one polyol component B,
(C) 1.0 to 2.5 wt % of water as component C, and
(D) 0.01 to 3 wt % of at least one Lewis base component D,
(E) 0 to 5 wt % of at least one foam stabilizer component E,
wherein said reacting is effected to release carbon dioxide.

2. The process according to claim 1 wherein water as component C is present in an amount of 1.3 to 2.5 wt %.

3. The process according to claim 1 wherein said polyol component B has an average molecular weight in the range from 200 g/mol to 6000 g/mol.

4. The process according to claim 1 wherein the polymer foam is a rigid polymer foam.

5. The process according to claim 1 wherein said component B has an OH number in the range from 10 mg KOH/g to 1000 mg KOH/g.

6. The process according to claim 1 wherein the polymer foam has a density in the range from 10 g/I to 250 g/I.

7. The process according to claim 1 wherein the Lewis base component D is selected from N-methylimidazole, melamine, guanidine, cyanuric acid, dicyandiamide and their derivatives or mixtures thereof.

8. The process according to claim 1 wherein said reacting is effected in the presence of a foam stabilizer component E comprising a siloxane copolymer.

9. The process according to claim 1 wherein said polyol component B is a polyether polyol or polyester polyol.

10. A polymer foam obtainable via the process according to claim 1.

11. A polymer foam deriving from polyisocyanates being to an extent of at least 10 wt %, condensation products comprising polyimide groups and obtained by condensing at least one polyisocyanate with at least one polycarboxylic acid having at least 3 COOH groups per molecule or anhydride thereof, polyols or an isocyanate-functional prepolymer thereof as monomers and water, including urethane, imide and urea groups in the polymer main chain.

12.-15. (canceled)

16. The process according to claim 7 wherein the Lewis base component D is N-methylimidazole.

17. The polymer foam of claim 11, wherein the polymer foam derives from polyisocyanates being to an extent of 100 wt %.

18. The polymer foam of claim 11, wherein the polymer foam has a foam density in the range from 10 kg/m³ to 250 kg/m³.
